(19) United States
(12) Patent Application Publication
(10) Pub. No.: US 2010/0267326 A1
(43) Pub. Date: Oct. 21, 2010

(54) VENTILATION DEVICE FOR WINDOWS

(76) Inventor: Young Ae Back, Daegu (KR)

Correspondence Address: MILORD & ASSOCIATES, P.C., 2029 Century Park East, SUITE 2100, LOS ANGELES, CA, 90067, US

(21) Appl. No.: 12/426,564

(22) Filed: Apr. 20, 2009

(51) Int. Cl. E06B 7/02

(52) U.S. Cl. 454/212

(57) ABSTRACT

A ventilation device installed for windows, which is located at the inner side of a window and has multiple inner ventilating openings on its side. The upper frame of the ventilation device is mounted on the window's upper frame, and Frame 1 of the device includes the lower frame, which is mounted on the window glass. The ventilation device also includes a flap, which can make a swing motion pivoting on a hinge structure, and Frame 2 with multiple outer ventilating openings on its side, which is attached to the outer bottom of the upper frame and the outer top of the lower frame in a detachable manner. It also includes an elevation part making the flap's opening and closing motions, a supporting part securing spaces for those movements, and an opening switch part originating the movement of the elevating parts. Frame 1 contains a hinge receiving part that can hold the swingable flap, and the opening switch located at the lower portion of the window.

### BACKGROUND OF THE INVENTION

1. Field of the Invention

The invention relates to a ventilation device, more specifically a ventilation device to be installed for windows that enhances the easiness and convenience of the opening and closing of the ventilation by placing the opening switch system at the lower region of a widow frame.

2. Description of Related Art

Circulation of air in most residential and commercial buildings is performed by opening windows for a time or by using separate ventilation systems. However, the circulation of air by opening widows results in a loss of significant energy as the heated air in winter or cooled air in summer escapes through the windows. It also causes financial burden because the inhaled air should be cooled down or heated up. Although more convenient than opening a window, the circulating of air by a separate ventilation system is used by only a few residential buildings due to the high installation and operation costs for the system.

Technology has been developed to solve some of the problems associated with ventilation systems, including the use of a small size ventilation device that can be installed at the inner side of a window in a detachable manner. The exemplary FIGS. 1a and 1b show an example of an existing ventilation device.

FIG. 1a is an exemplary skew drawing of a window ventilation device that is installed by the existing technology, and FIG. 1b is a sectional view detailed drawing of the ventilation device shown in FIG. 1a. In referring to both FIGS. 1a and 1b, the ventilation device (100) of the existing technology is placed between the window glass (110) and the upper frame (120) of a window. The window ventilation device (100) is located at the inner side of a window and has multiple ventilating openings (132) on its side. The window ventilation device (100) is comprised of a Frame 1 (130), a Frame 2, and the ventilation-opening switch (160). Frame 1, in turn, is composed of the Upper Frame 1 (134) that has a top surface that is complementary to the upper frame of the window (120), and includes the Lower Frame 1 (136) that has a bottom that is complementary to the shape of glass (110). The ventilation device (100) also includes a flap (140), which has a swing motion, pivoting on a hinge structure (142), and Frame 2 (150). Frame 2, in turn, is comprised of a hinge receiving part that can hold the pivoting, swinging flap (140), and Upper Frame 2 (152) that fits to the window's upper frame (120) located at the outer side of the window, facing Frame 1 (130). An opening switch (160) that is connected to the bottom of the flap and can originate the flap's movements is also included with the device. The outer ventilating opening (146) is located between the bottom of Frame 2 (150) and Lower Frame 1 (136) of Frame 1 (130). In this case, the outer ventilation (146) can be either empty opening or a individual frame or plate that is similar in shape to the inner ventilation (132). The flap (140) can be placed to the open or closed positions by turning the handle (162) of the switch (160), which actualizes the performance of the ventilation device (100).

As illustrated in the FIGS. 1a and 1b, the switch (160) of the window ventilation device (100) is most likely located high, above the height of 2 meter due to the size of window. Obviously, most individuals cannot reach that height, and therefore are not able to use the control switch (160), requiring the use of other equipment such as a ladder to reach switch (160).

Though a string can be tied to the switch (160) or a stick may be used to move the switch (160) to one of open and closed positions, both are inconvenient and do not look good. In addition, if venetian blinds are installed, the problem mentioned above will be worsened due to existing strings and sticks already associated with the blinds. Therefore, a new type of the window ventilation device is needed to solve the problems associated with the existing window ventilation device (100).

### BRIEF SUMMARY OF THE INVENTION

An aspect of the present invention provides a new window ventilation device that promotes the easiness and convenience for using the ventilation device by placing the ventilation-opening switch, which was attached to the device at the upper region of a window of the previous system, at the lower region of the window frames.

In order to accomplish the above aspect, a window ventilation device according to the invention is provided that is located at the inner side of a window that has multiple inner ventilating openings on its side. The upper frame of the ventilation device is mounted on the window's upper frame, and Frame 1 of the device includes the lower frame, which is mounted on the window glass. The ventilation device also includes a flap, which pivotally swings on a hinge structure, and Frame 2 with multiple outer ventilating openings on its side, which is attached to the outer bottom of the upper frame and the outer top of the lower frame in a detachable manner. The window ventilation device of the present invention also includes an elevation part that facilitates the movement of the flap to one of open and close positions. Further included is a supporting part securing spaces for the movement of the flap, and an opening switch part originating the movement of the elevating parts. Frame 1 contains a hinge receiving part that can hold the swingable flap, and further includes the opening switch that is located at the lower portion of the window.

The ventilation device installed for windows includes an opening and closing of the ventilation device are easy because the ventilation-opening switch is located at the middle or lower region of the window frame. As the opening switch is placed at the middle or lower region of the window frame, there is no need for using equipment such as chairs to reach the switch. Unlike previously employed alternatives such as attaching a string to the switch or using a stick to move the switch, the elevating parts that connects main device and the switch is built-in inside the window frame, so appearance will be enhanced. Even for windows with venetian blinds, opening and closing of the ventilation device is easy and convenient.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1a is an exemplary skew drawing of a window ventilation device that is installed by the existing technology.

FIG. 1b is an exemplary section drawing that roughly shows the section details of window ventilation device's illustrated in FIG. 1a.

FIG. 2a is an exemplary skew drawing that shows a part of the ventilation device installed at the upper region of a window according to the invention.

FIG. 2b is an exemplary skew drawing that shows a part of the ventilation device with the swingable flap at its closing position and the removed outer frame (Frame 2) from the window ventilation device as in FIG. 2a, according to the invention.

FIG. 2c is an exemplary skew drawing that shows a part of the ventilation device with the swingable flap at its closing position and the removed outer frame (Frame 2) from the window ventilation device as in FIG. 2a, according to the invention.

FIG. 2d is an exemplary section details drawing that shows the ventilation device with the swingable flap at both open and close position and the retained outer frame (Frame 2) from the window ventilation device as in FIGS. 2b and 2c, according to the invention.

FIG. 2e is an exemplary exploded skew drawing that shows the elevation part is being received into a gap between the elevation receiving part and the grooved part after passing the supporting parts of the window ventilation device as in FIG. 2a, according to the invention.

FIG. 2f is an exemplary drawing that roughly shows a combination action being resulted by the elevation part, the flap, and the grooved part on Frame 1.

FIG. 2g is an exemplary skew drawing that roughly shows the elevation parts; FIG. 2h is a drawing that specifically shows the joint portion (A) of the elevation parts as in FIG. 2g.

FIG. 2i is an exemplary drawing that shows specific example of the joint portion (A) of the elevation parts as in FIG. 2g; FIG. 2j is a skew drawing that roughly shows the ventilation-opening switch connected to the lower longitudinal bar of the elevation parts.

FIG. 2j is an exemplary skew drawing that roughly shows the opening switch part being connected to the lower vertical bar of the elevation part.

FIG. 2k is an exemplary skew drawing that illustrates the handle, a fastener, a sliding part, a lower plate, on which the positioning part of the sliding part lies, of the opening switch, as illustrated in FIG. 2f, and their functions, viewed from the right-hand side.

FIG. 2l is an exemplary skew drawing that shows an upper plate (or a cover plate) of the opening switch, illustrated in 2k, that covers the lower plate, illustrated in FIG. 2k, viewed from the rear side.

FIG. 3 is an exemplary front view drawing that shows the opening switch part of the window ventilation device according to the invention is fixed at the left-middle or lower region of the window frame.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

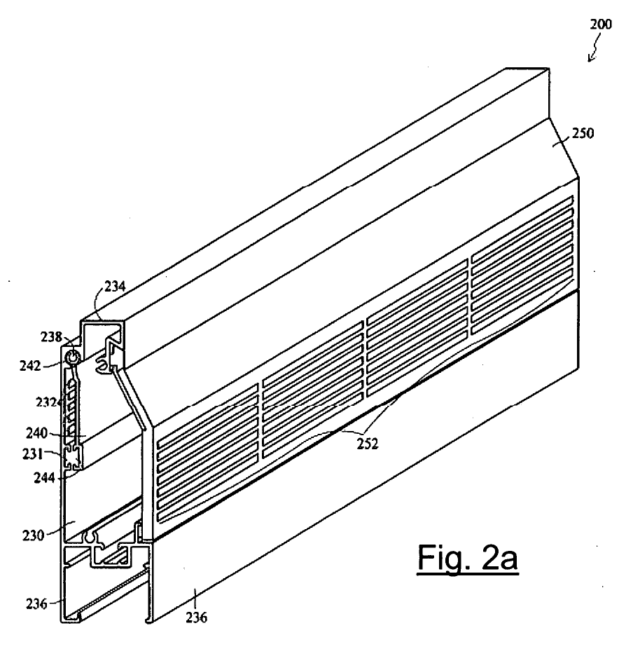

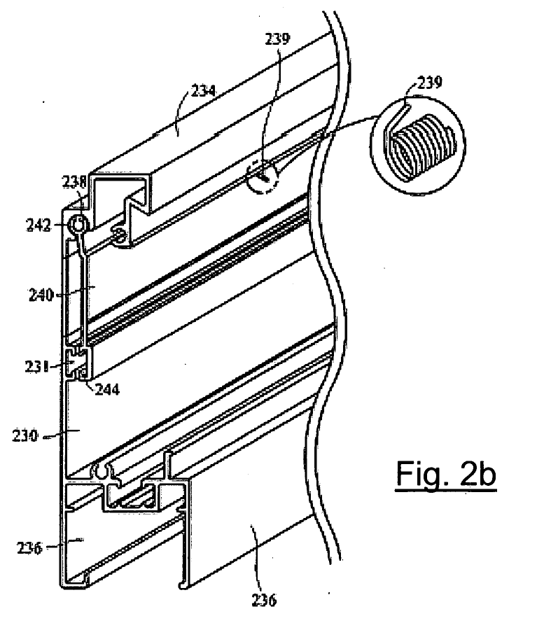

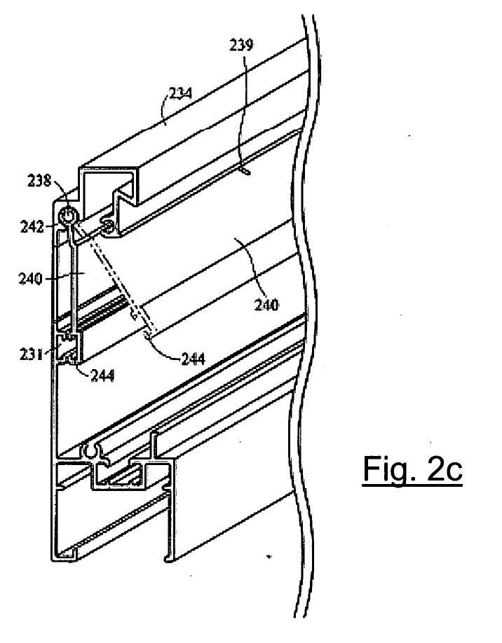

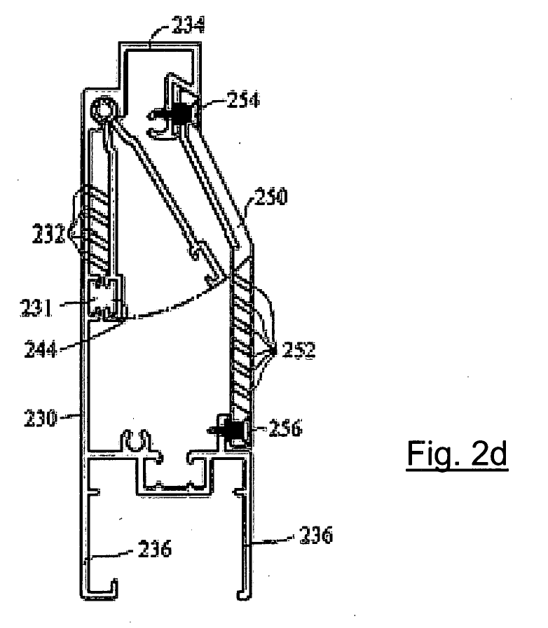

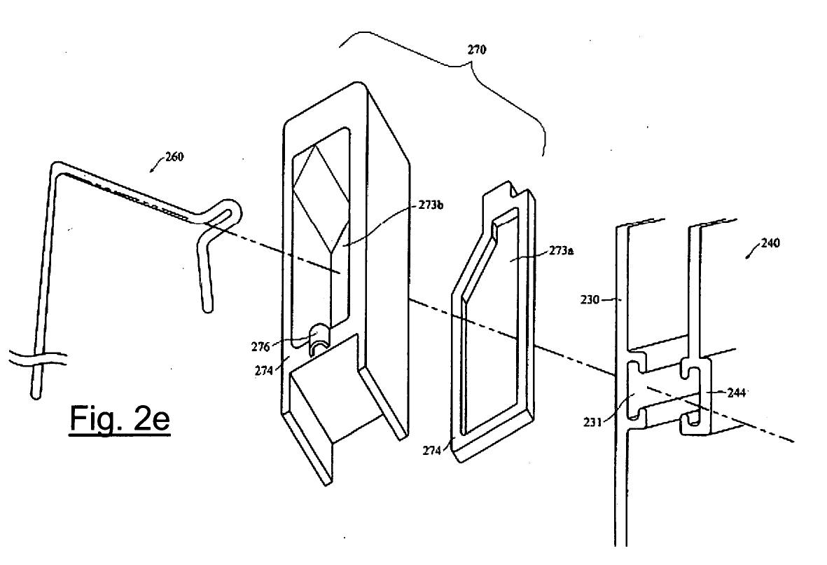

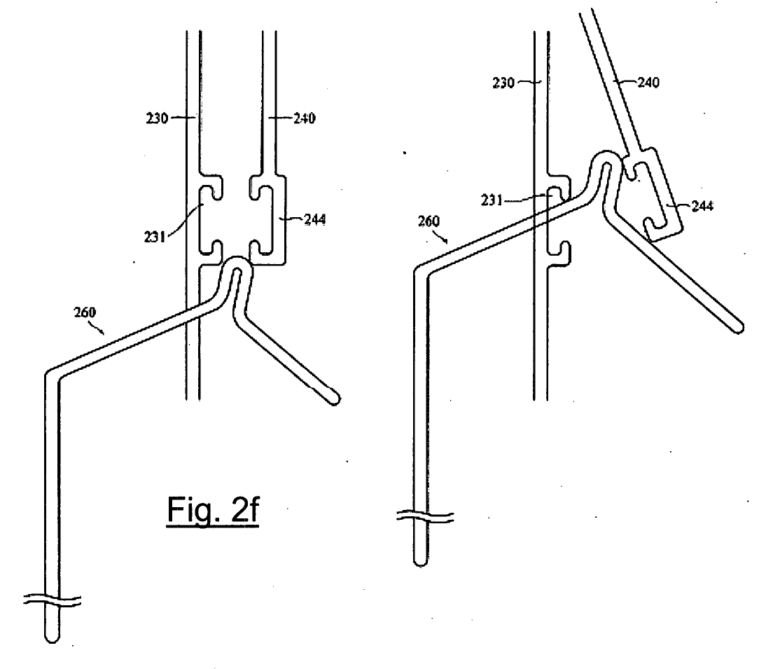

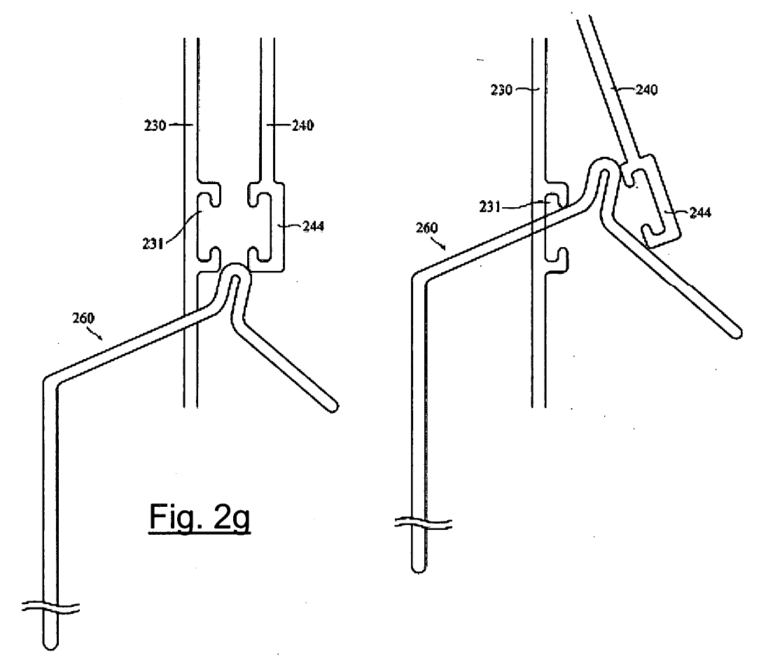

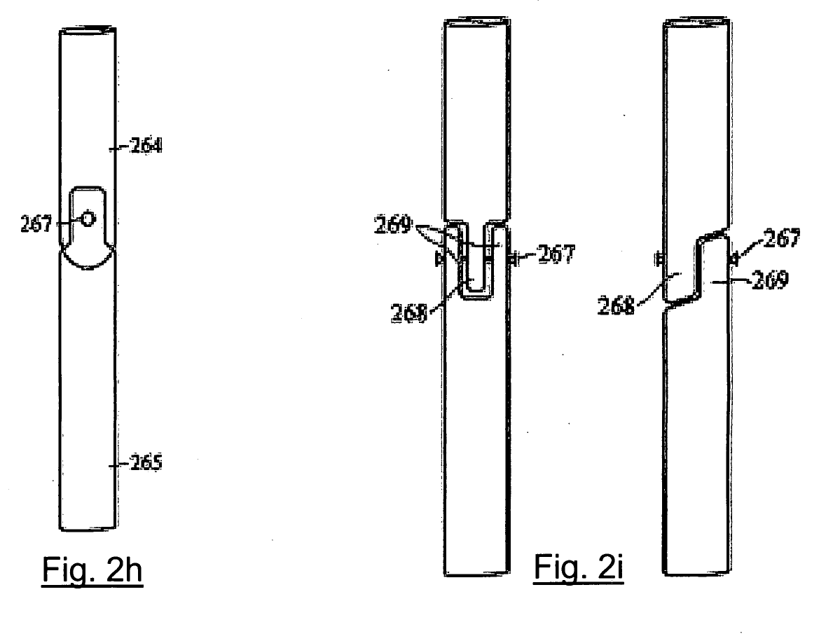

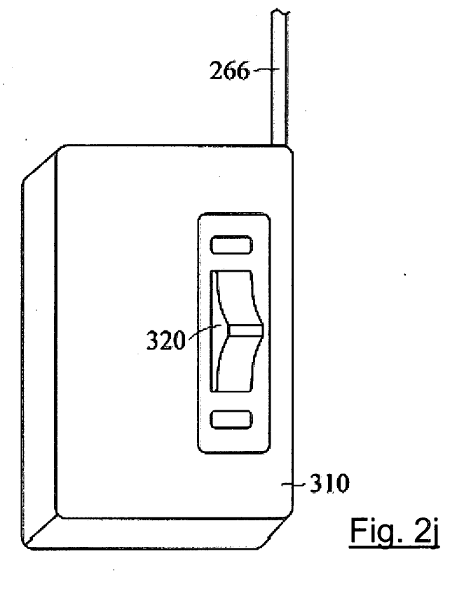

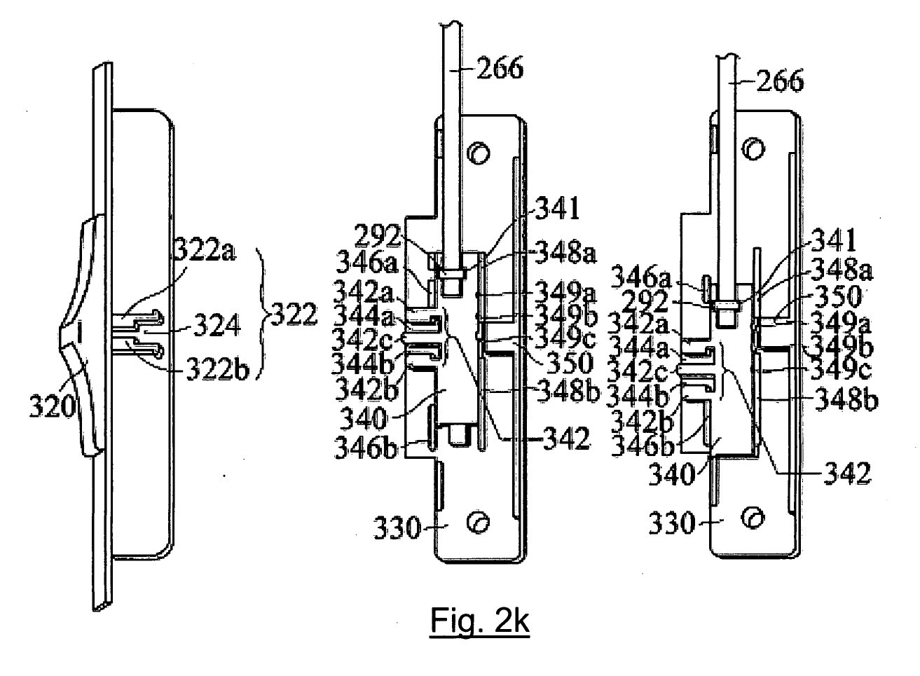

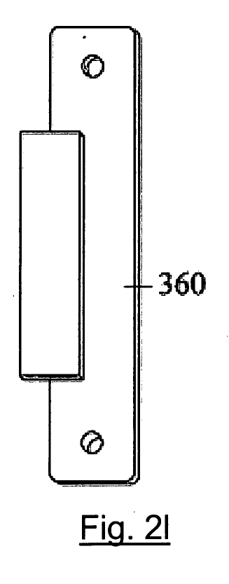

FIG. 2a is a skew drawing that shows a part of the ventilation device installed at the upper region of a window according to the invention; FIG. 2b is a skew drawing that shows a part of the ventilation device with the swingable flap at its closing position and the removed outer frame (Frame 2) from the window ventilation device as in FIG. 2a, according to the invention; FIG. 2c is a skew drawing that shows a part of the ventilation device with the swingable flap at its closing position and the removed outer frame (Frame 2) from the window ventilation device as in FIG. 2a, according to the invention; FIG. 2d is a section details drawing that shows the ventilation device with the swingable flap at both open and close position and the retained outer frame (Frame 2) from the window ventilation device as in FIGS. 2b and 2c, according to the invention; FIG. 2e is a exploded skew drawing that shows the elevation part is being received into a gap between the elevation receiving part and the grooved part after passing the supporting parts of the window ventilation device as in FIG. 2a, according to the invention; FIG. 2f is a drawing that roughly shows a combination action being resulted by the elevation part, the flap, and the grooved part on Frame 1; FIG. 2g is a skew drawing that roughly shows the elevation parts; FIG. 2h is a drawing that specifically shows the joint portion (A) of the elevation parts as in FIG. 2g; FIG. 2i is a drawing that shows specific example of the joint portion (A) of the elevation parts as in FIG. 2g; FIG. 2j is a skew drawing that roughly shows the ventilation-opening switch connected to the lower longitudinal bar of the elevation parts.

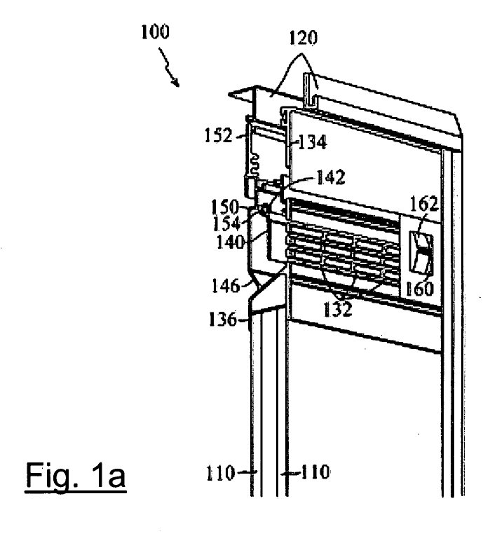

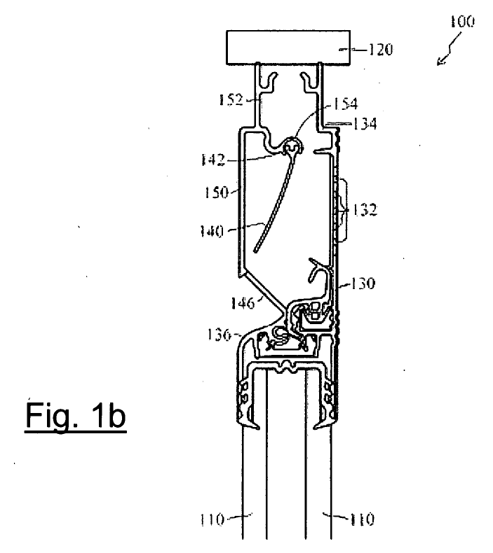

Referring to FIG. 2a to 2j, the ventilation device for installation for windows according to the invention is positioned between the window glass (110), as illustrated in FIG. 1, and the upper window frame (120). This ventilation device, to be installed for windows (200), is located at the inner side of a window and has multiple inner ventilating openings (232) on its side. The upper frame of the ventilation device is mounted to the window's upper frame (120, refer to FIG. 1) appropriately, and Frame 1 (230) of the device includes the lower frame (236) that is mounted to the window glass (110, refer to FIG. 1) appropriately. The ventilation device also includes a flap (240), which can make a swinging motion, pivoting on a hinge structure (242), and Frame 2 (250) with multiple outer ventilating openings (252) on its side, which is attached to the outer bottom of the upper frame (234) and the outer top of the lower frame (236) of Frame 1 (230) in a detachable manner. It also includes an elevation part (260) making the flap's (240) opening and closing motions, a supporting part (270) securing spaces (273a, 273b) for those movements, and an opening switch part (310) originating the movement of the elevation part (260). Frame 1 (230) contains a hinge receiving part (238) that can hold the swinging flap (240), with the switch part (310) located at the lower portion of the window. In the following, each component part of the window ventilation device (200), described above, and their combination are described further.

In referring to FIG. 2a to 2j, the hinge part (242) in the flap (240) is received into the hinge receiving part (238) of the Frame 1 (230) of the window ventilation device (200) according to the invention. However, when the flap (240) swings from the open position as in FIG. 2c to the close position as in FIG. 2b, the flap might not properly close due to dust particles or friction between the flap's (240) hinge (242) and the hinge receiving part (238) of Frame 1 (230). To reduce the probability of not properly closing, one or more springs (239) are installed in the upper frame (234). The springs (239) apply resilience (dynamic stability) toward the flap's (240) closed position by pushing the outer surface of the flap (240). The use of the spring (239) is optional.

To reduce noise from collision between the part (244) receiving the elevation parts and the grooved part (231) in Frame 1 (230) that faces the receiving part (244), a shock absorbing material (not illustrated), which is made of rubber or a resilient material, can be installed at the flap (240) as in FIGS. 2b and 2c. This shock absorbing material is optional.

Referring to FIG. 2d, if the flap (240) is at its closed position (perpendicular angle), air passage between the inner multiple openings (232) and the outer multiple openings (253) is blocked. On the other hand, if the flap (240) is at its opened position (on an inclined plane), air passage between the inner multiple openings (232) and the outer multiple openings (252) is open, resulting in ventilation. As illustrated in FIG. 2d, Frame 2 (250) is attached to Frame 1 (230) in a detachable manner by upper and lower screw fasteners (254, 256).

FIG. 2e is an exploded skew drawing showing the elevation parts (260) is received into the gap between the receiving part (244) for the elevation part and the grooved part (231) through the supporting parts. More specifically, the elevation part (260) is received into the gap between the receiving part (244) for the elevation parts and the grooved part (231) of Frame 1 (230) through the supporting part cluster (270), which is formed by combining first supporting part (272) and the second supporting part (274) in a snapping manner. To make the receiving action, the first supporting part (272) and the second supporting part (274) secure the first space (273a) and the second space (273b) to allow the elevation and descending motions. Though the example of FIG. 2e illustrates the first supporting part (272) and the second supporting part (274) separately, two parts can be supplied as a combined piece. In addition, a guiding groove (276) in the middle of bottom line of the second supporting part (274) is preferred in order to prevent a side movement (i.e., the direction from the second supporting part (274) to further outside) of the elevation parts (260). The guiding groove (276) can be made in the shape of a semicircle and of two pieces that perpendicularly cut into its center.

Referring FIGS. 2f and 2g, the elevation parts (260) is received into the gap between the receiving part (244) for the elevation parts on the flap (240) and the grooved part (231) in the Frame 1 (230). For the action, the elevation parts (260) is comprised of a bar (261), a convex bending portion (262) at one side of the bar (261), a slant extension (263) from the bending portion, and vertical bar (264, 265) at the other side of the bar (261) (refer to FIG. 2g). The bar (261) of the elevation part (260) as in FIG. 2e can make up-and-down movements within the first and second space (273a, 273b) of the supporting part (270). The convex bending portion (262) of the elevation part (260) is received into the gap between the receiving part (244) for the elevation parts on the flap (240) and the grooved part (231) in the Frame 1 (230), as illustrated in FIG. 2f. Once the elevation part (260) lifts, the flap (240) is moved to its open position by the lifting action of the slant extension (263) into the receiving part for the elevation part. When the elevation part (260) descends, the flap (240) is moved to its closed position by the descending action of the slant extension out of the receiving part for the elevation part. If the elevation part (260) descends to its lowest position, the convex bending portion is laid between the receiving part (244) for the elevation part and the grooved part (231).

Referring to FIG. 2g to 2i, the vertical bar (264, 265) of the elevation part (260) is preferably made of two pieces, which are an upper vertical bar (264) and a lower vertical bar (265). The elevation part (260) is preferably made of a metal. However, the elevation part (260) may be made of any rigid body. The upper vertical bar (264) and the lower vertical bar (265) of the elevation part are to be connected by a fastener such as a rivet in a foldable manner (refer to FIG. 2h). The connection of the upper vertical bar (264) and the lower vertical bar (265) is made, for example, by inserting the protruded portion (268) of the upper vertical bar (264) into the space between two protruded portions (269) of the lower vertical bar and fixing the fastener (267) through the engaged protruded portions. Another method of connection is connecting the protruded portion (268) of the upper vertical bar (264) to another protruded portion (269) at the top of the lower vertical bar (265) by fixing the fastener (267) through the engaged portions. In both cases, the lower vertical bar (265) can be bent perpendicularly and inserted into the lower frame (236) as illustrated in FIG. 2a. One advantage of making the vertical bar (264, 265) in two pieces, one upper vertical bar (264) and one lower vertical bar (265), is the convenience of transportation before the assembly of the window ventilation device (200). However, making the vertical bar (264, 265) into two pieces, one upper vertical bar (264) and one lower vertical bar (265), is just an example, so it can be made as one piece if necessary. The lower terminal portion of the lower vertical bar is connected to the opening switch part (310), as illustrated in FIG. 2j.

Referring to FIG. 2j, the elevation part (260) as in FIG. 2g is to be connected to the opening switch part (310) through its lower terminal portion (266) of the lower vertical bar (265). The length of the elevation part (260) can be adjusted by the size of the window or window frame. Meanwhile, the elevation part (260) makes up-and-down movement in connection with the up-and-down motion in the opening switch part (310). The elevation part (260) conveys the up-and-down movement to the convex bending portion (262) and the slant extension (263), then ultimately controls the flap's (240) positions.

FIG. 2k is a skew drawing that illustrates the handle, a fastener, a sliding part, and a lower plate (on which the positioning part of the sliding part lies) of the opening switch, and their functions, viewed from the right-hand side. FIG. 2l is a skew drawing that shows an upper plate (or a cover plate) of the opening switch, illustrated in 2k, that covers the lower plate, illustrated in FIG. 2k, viewed from the rear side.

Referring to FIGS. 2k and 2l, the lower terminal portion (266) of the lower vertical bar (265) in the elevation part (260) is connected to the sliding part (340) of the lower plate (330). More specifically, a receiving portion (341) for the lower terminal portion (266) of the lower vertical bar (265) is located at the upper region of the sliding part (340), and the receiving portion (341) and the lower terminal portion (266) of the lower vertical bar (265) are connected by an engaging part (292). The handle (320) of the opening switch part (310) contains a connecting part (322) comprised of two protruded parts (322a, 322b). There is a receiving space (324) between two protruded parts (322a, 322b), and the sliding part (340) has its connecting part, three to five protruded parts (342a, 342b, 342c) that are complementary to the handle's (320) connecting part (322) on its side (left side in FIG. 2k). There are also receiving spaces (344a, 344b) between the third and forth protruded parts (342a, 342b) and between the forth and fifth protruded parts (342b, 342c). The protruded parts (322a, 322b) of the handle (320) are received by the spaces (344a, 344b) in the sliding part (340), and the fifth protruded part (342c) of the sliding part (340) is received by the space (324) of the handle (320). The connecting part (322) of the handle (320) and the connecting part (342) of the sliding part (340) are combined by snapping.

Each pair of guiding parts No. 1 (346a, 346b) and guiding parts No. 2 (348a, 348b) are installed on the lower plate (330) to guide up-and-down the movement of the sliding part (340) connected to the handle (320). A pair of the guiding part No. 1 (346a, 346b) is installed not to obstruct (but to facilitate and enable) the movement of the connecting part (342), and a pair of the guiding part No. 2 (348a, 348b) is installed not to obstruct (but to facilitate and enable) the movement of the position control part (350) of the sliding part (350). To make a smooth and accurate movement of the switch, multiple grooves (349a, 349b, 349c) are made on one side (on the right side in FIG. 2k) of the sliding part (340). The position control part (350) contains a ball bearing or a resilient protrusion (not illustrated) interiorly to make the sliding part (340) stay intermittently at the multiple grooves (349a, 349b, 349c). The number of the multiple grooves for the sliding part (340) in FIG. 2k is three, but it may be changed upon necessity. By changing the number and position of the grooves (349a, 349b, 349c) the swing motion of the flap (240) can be adjusted. In referring to the examples illustrated in FIG. 2k, the sliding part (340) of the second drawing shows that the handle (320) is moved upward, and the sliding part (340) of the third drawing shows that the handle (320) is positioned low.

The upper plate (or cover plate) (360) in FIG. 2l and the lower plate (330) in FIG. 2k can be combined by snapping mechanism or using separate fasteners such as screw nail (not illustrated).

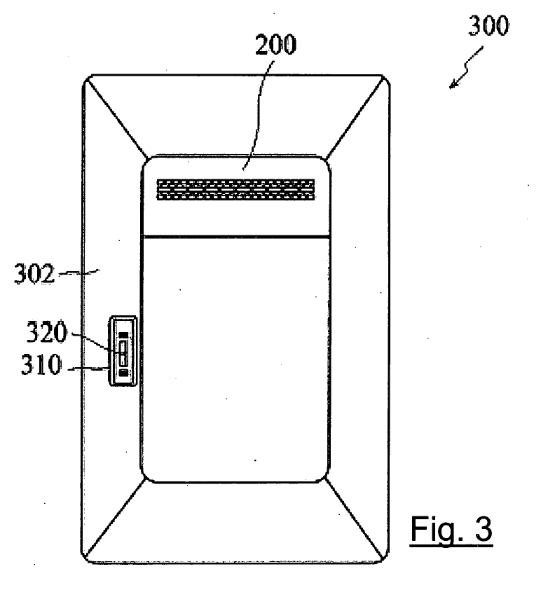

FIG. 3 a front view drawing that shows the opening switch part of the window ventilation device according to the invention, which is fixed at the left-middle or lower region of the window frame.

Referring to FIG. 3, the opening switch part (310) of the ventilation device (200) installed for windows (300) according to the invention is located at the left-middle or lower region of the window frame (302). Referring FIG. 2a to 2l, as the component parts of the ventilation device installed for windows (200) according to the invention, the supporting part (270), the elevation part (260), the sliding part (340), the position control part (350) for the sliding part (340), the lower plate (330), and the upper plate (360) are installed inside the left window frame (320). Consequently, only the opening switch part (310) with its handle (320) is installed at the middle or lower region of the window frame (302), enhancing the easiness and convenience of ventilation as well as the exterior appearance.

The ventilation device to be installed for windows (200) is described above as its opening switch (310) placed at the middle of lower region of the left window frame (301), the switch (310) of the ventilation device (200) can be installed to the middle of lower region of the right window frame (301) in the same manner.

Though the ventilation device (200) is also described above as used for windows, the device can be installed to any place that needs ventilation (i.e., walls and ceilings). Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A ventilation device installed for windows, and positioning inside a window, comprising:
multiple inner ventilating openings on the side,
an upper frame appropriately combining with the upper frame of a window,
Frame 1 appropriately combining with the glass of a window, a swingable flap containing hinge portion,
Frame 2 with multiple outer ventilating openings on Frame 2 side that is attached to the Frame 1 by combining at outer bottom of the upper frame and the outer top of the lower frame in a detachable manner,
an elevation part that makes up-and-down motion to move the flap,
a supporting part that secures spaces for the movements of the elevation part,
an opening switch part that is attached to the lower terminal portion of the elevation part and moves the elevation part up-and-down,
a hinge receiving portion in the Frame 1 that holds the flap, and the installation of the open switch part at the lower region of the window.

2. The ventilation device as set forth in claim 1, wherein: one or more springs are arranged for attaining resilient output to make flap stay at the close position by touching the outer surface of the flap.

3. The ventilation device as set forth in claim 1, wherein: the flap is arranged to contains a receiving part for the elevation part with a grooved portion facing the receiving part, and a shock absorbing material is arranged to be installed on either the receiving part or the grooved part.

4. The ventilation device as set forth in claim 2, wherein: the flap is arranged to contain a receiving part for the elevation part and a grooved portion facing the receiving part, and a shock absorbing material is arranged to be installed on one or both of the receiving part and the grooved part.

5. The ventilation device as set forth in claim 1, wherein: the supporting part is arranged to comprise a supporting part No. 1 and No. 2 that are combined by snapping up each other, and the supporting part No. 1 and No. 2 are arranged to contain space No. 1 and No. 2 securing spaces for the up-and-down movements of the elevation part.

6. The ventilation device as set forth in claim 5, wherein: the supporting part No. 1 and No. 2 are arranged to be combined to one complex body, and space No. 1 and No. 2 are arranged to be combined to one space.

7. The ventilation device as set forth in claim 5, wherein: the supporting part is arranged to contain guiding grooves to prevent lateral movement of the elevation part upon its up-and-down movements.

8. The ventilation device as set forth in claim 1, wherein: the elevation part is made of a metal.

9. The ventilation device as set forth in claim 1, wherein: the elevation part includes a bar, a convex bending portion continued form the bar, a slant extension continued from the convex bending portion, and a vertical bar continued from an other side of the bar.

10. The ventilation device as set forth in claim 9, wherein: the vertical bar is arranged to include an upper vertical bar and a lower vertical bar, and the upper and lower vertical bars are combined by a fastener in a foldable manner.

11. The ventilation device as set forth in claim 9, wherein:
the opening switch part includes a handle that is combined with the lower terminal portion of the vertical bar,
a sliding part that moves the vertical bar up-and-down in connection with the handle,
a position control part that adjust the sliding part,
a lower plate on which the position control part is installed,
an upper plate that is combined with the lower plate, and
pairs of guiding part No. 1 and No. 2 that guide the sliding part's longitudinal movements and are separated.

12. The ventilation device as set forth in claim 11, wherein: the sliding part includes multiple grooves on side, and the position control part includes one of a ball bearing and a resilient protrusion to intermittently control the sliding part on the position of the multiple grooves.
